(19) United States
(12) Patent Application Publication
(10) Pub. No.: US 2009/0103779 A1
(43) Pub. Date: Apr. 23, 2009

(54) MULTI-SENSORIAL HYPOTHESIS BASED OBJECT DETECTOR AND OBJECT PURSUER

(75) Inventors: Otto Loehlein, Illerkirchberg (DE); Werner Ritter, Ulm (DE); Axel Roth, Ulm (DE); Roland Schweiger, Ulm (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/294,021

(22) PCT Filed: Mar. 19, 2007
(86) PCT No.: PCT/EP07/02411

§ 371 Date: Sep. 22, 2008

(30) Foreign Application Priority Data
Mar. 22, 2006 (DE) 102006013597.0

(51) Int. Cl. G06K 9/00; G06K 9/62

(52) U.S. Cl. 382/103; 382/224

(57) ABSTRACT

The invention relates to a method for multi-sensorial object detection, wherein sensor information is evaluated together from several different sensor signal flows having different sensor signal properties. For said evaluation, the at least two sensor signal flows are not adapted to each other and/or projected onto each other, but object hypotheses are generated in each of the at least two sensor signal flows and characteristics for at least one classifier are generated based of said object hypotheses. Said object hypotheses are subsequently evaluated by means of a classifier and are associated with one or more categories. At least two categories are identified and the object is associated with one of the two categories.

The invention relates to a method for multisensor object identification.

Computer-based evaluation of sensor signals for object recognition and object tracking is already known from the prior art. For example, driver assistance systems are available for road vehicles, which systems recognize and track preceding vehicles by means of radar in order, for example, to automatically control the speed and the distance of one's own vehicle from the preceding traffic. Furthermore, widely different types of sensors, such as radar, laser sensors and camera sensors, are already known for use in the area around a vehicle. The characteristics of these sensors differ widely, and they have various advantageous and disadvantages. For example, sensors such as these have different resolution capabilities or spectral sensitivity. It would therefore be particularly advantageous to use a plurality of different sensors at the same time in a driver assistance system. However, at the moment, multisensor use is virtually impossible since variables detected by means of different types of sensors can be directly compared or combined in a suitable manner only with considerable signal evaluation complexity.

The individual sensor streams in the system known from the prior art are therefore first of all matched to one another before they are fused with one another. For example, the images from two cameras with different resolution capabilities are first of all mapped in a complex form with individual pixel accuracy onto one another, before being fused to one another.

The invention is therefore based on the object of providing a method for multisensor object recognition, by which means objects can be recognized and tracked in a simple and reliable manner.

According to the invention, the object is achieved by a method having the features of patent claim 1. Advantageous refinements and developments are specified in the dependant claims.

According to the invention, a method is provided for multisensor object recognition in which sensor information from at least two different sensor signal streams with different sensor signal characteristics is used for joint evaluation. In this case, the sensor signal streams are not matched to one another and/or mapped onto one another for evaluation. First of all, the at least two essential signal streams are used to generate object hypotheses, and features for at least one classifier are then generated on the basis of these object hypotheses. The object hypotheses are then assessed by means of the at least one classifier, and are associated with one or more classes. In this case, at least two classes are defined, with objects being associated with one of the two classes. The method according to the invention therefore for the first time allows simple and reliable object recognition. There is no need whatsoever in this case for complex matching of different sensor signal streams to one another, or for mapping them onto one another, in a manner that results in a particular improvement. For the purposes of the method according to the invention, the sensor information items from the at least two sensor signal streams are in fact directly combined with one another and fused with one another. This considerably simplifies the evaluation, and short computation times are possible. Since no additional steps are required for matching of the individual sensor signal streams, the number of possible error sources in the evaluation is minimized.

The object hypotheses can either be unambiguously associated with one class or they are associated with a plurality of classes, with the respective association being allocated a probability.

The object hypotheses are generated individually in each sensor signal stream independently of one another, in a manner which results in an improvement, in which case the object hypotheses from different sensor signal streams can then be associated with one another by means of association rules. In this case, the object hypotheses are generated first of all in each sensor signal stream by means of search windows in a previously defined 3D state area which is covered by physical variables. The object hypotheses generated in the individual sensor signal streams can be associated with one another later on the basis of the defined 3D state area. For example, the object hypotheses from two different sensor signal streams are classified later in pairs in the subsequent classification process, with one object hypothesis being formed from one search window pair. If there are more than two sensor signal streams, one search window is in each case used corresponding thereto from each sensor signal stream, and an object hypothesis is formed therefrom, which is then transferred to the classifier for joint evaluation. The physical variables for covering the 3D state area may, for example, be one or more components of the object extent, a speed parameter and/or an acceleration parameter, or a time etc. The state area may in this case also have a greater number of dimensions.

In a further manner which results in an improvement to the invention, object hypotheses are generated in a sensor signal stream (primary stream) and the object hypotheses in the primary stream are then projected into other image streams (secondary streams) with one object hypothesis in the primary stream producing one or more object hypotheses in the secondary stream. When using a camera sensor, the object hypotheses in the primary stream are in this case generated, for example, on the basis of a search window within the images recorded by means of the camera sensor. The object hypotheses generated in the primary stream are then projected by computation into one or more other sensor streams. In a further advantageous manner, the projection of object hypotheses from the primary stream into a secondary stream is in this case based on the sensor models used and/or the positions of search windows within the primary stream, and/or on the epipolar geometry of the sensors used. In this context, ambiguities can also occur in the projection process. An object hypothesis/search window of the primary stream generates a plurality of object hypotheses/search windows in the secondary stream, for example because of different object separations from the individual sensors. The object hypotheses generated in this way are then preferably transferred in pairs to the classifier. In this case, pairs of the object hypotheses from the primary stream and an object hypothesis from the secondary stream are in each case formed, and then are transferred to the classifier. However, it is also possible to transfer all of the object hypotheses generated in the secondary streams or parts of them to the classifier, in an addition to the object hypothesis from the primary stream.

Object hypotheses will be described in a manner which results in an improvement in conjunction with the invention, by means of the object type, object position, object extent, object orientation, object movement parameters such as the movement direction and speed, object hazard potential or any desired combination thereof. Furthermore, these may also be any desired other parameters which describe the object characteristics, for example speed and/or acceleration values associated with an object. This is particularly advantageous if the method according to the invention is used not only for pure object recognition but also for object tracking, and the evaluation process also includes tracking.

In a further advantageous manner according to the invention, object hypotheses are randomly scattered in a physical search area or produced in a grid. By way of example, search windows with a predetermined stepwidth within the search area are varied on the basis of a grid. However, it is also possible to use search windows only within predetermined areas of the state area where there is a high probability of objects occurring, and to generate object hypotheses in this way. However, the object hypotheses can also be created in a physical search area by means of a physical model. The search area can be adaptively constrained by external presets such as the beam angle, range zones, statistical characteristic variables which are obtained locally in the image, and/or measurements from other sensors.

For the purposes of the invention, the various sensor signal characteristics in the sensor signal streams are based on different positions and/or orientations and/or sensor variables of the sensors used. In addition to position and/or orientation discrepancies, or individual components thereof, discrepancies in the sensor variables that are main cause different sensor signal characteristics in the individual sensor signal streams. For example, camera sensors with a different resolution capability cause differences in the image recording variables. In addition, image areas of different size are also frequently recorded, because of different camera optics. Furthermore, for example, the physical characteristics of the camera chips may be completely different, so that, for example, one camera records information relating to the surrounding area in the visible wavelength spectrum, and a further camera records information relating to the surrounding area in the infrared spectrum, in which case the images may have a completely different resolution capability.

For evaluation purposes, it is advantageously possible for each object hypothesis to be classified individually in its own right, and for the results of the individual classifications to be combined, with at least one classifier being provided. If a plurality of classifiers are used, one classifier may in each case be provided in this case, for example for each different type of object. If only one classifier is provided, each object hypothesis is first of all classified by means of the classifier, and the results of a plurality of individual classifications are then combined to form an overall result. Various evaluation strategies are known for this purpose by those skilled in the art in the field of pattern recognition and classification. However, in a further advantageous manner, the invention also allows features of object hypotheses in different sensor signal streams to be assessed jointly in the at least one classifier, and to be combined to form a classification result. In this case, by way of example, a predetermined number of object hypotheses must reach a minimum probability for the class association with this specific object class in order to reliably recognize a specific object. Widely different evaluation strategies are also known in this context to those skilled in the art in the field of pattern recognition and classification.

Furthermore, it is a major advantage if the grid in which the object hypotheses are produced is adaptively matched as a function of the classification result. For example, the grid width is adaptively matched as a function of the classification result, with object hypotheses being generated only at the grid points, and/or with search windows being positioned only at grid points. If object hypotheses are increasingly not associated with any object class or no object hypotheses are generated at all, the grid width is preferably selected to be smaller. In contrast to this, the grid width is selected to be larger if object hypotheses are increasingly associated with one object class, or the probability of object class association rises. In this context, it is also possible to use a hierarchical structure for the hypothesis grid. Furthermore, the grid can be adaptively matched as a function of the classification result of a previous time step, possibly including a dynamic system model.

In a further advantageous manner, the evaluation method by means of which the object hypotheses are assessed is automatically matched as a function of at least one previous assessment. In this case, by way of example, only the most recent previous classification result or else a plurality of previous classification results are taken into account. For example, in this case, only individual parameters of one evaluation method and/or a suitable evaluation method from a plurality of evaluation methods are selected. In principle, in this context, widely differing evaluation methods are possible and, for example, may be based on statistical and/or model-based approaches. The nature of the evaluation methods available for selection in this case also depends on the nature of the sensors used.

Furthermore, it is also possible not only for the grid to be adaptively matched but also for the evaluation method used for assessment to be matched as a function of the classification result. The grid is refined, in a manner resulting in an improvement, only at those positions in the search area where the probability or assessment of the presence of objects is sufficiently high, with the assessment being derived from the last grid steps.

The various sensor signal streams may be used at the same time, or else with a time offset. In precisely the same way, it is advantageously also possible to use a single sensor signal stream together with at least one time-offset version.

The method according to the invention can be used not only for object recognition but also for tracking of recognized objects.

In particular, the method can be used to record the surrounding area and/or for object tracking in a road vehicle. For example, a combination of a color camera, which is sensitive in the visible wavelength spectrum, and of a camera which is sensitive in the infrared wavelength spectrum is suitable for use in a road vehicle. At night, this on the one hand allows people to be detected, and on the other hand allows the color signal lights of traffic lights in the area surrounding the road vehicle to be detected in a reliable manner. The information items supplied from the two sensors are in this case evaluated using the method according to the invention for multisensor object recognition in order, for example, to recognize and to track people contained therein. The sensor information is in this case preferably presented to the driver on a display unit, which is arranged in the vehicle cockpit, in the form of image data, with people and signal lights of traffic light system being emphasized in the displayed image information. In addition to cameras, radar sensors and lidar sensors in particular are also suitable for use as sensors in a road vehicle, in conjunction with the method according to the invention. The method according to the invention is also suitable for use with widely differing types of image sensors and any other desired sensors known from the prior art.

Further features and advantages of the invention will become evident from the following description of preferred exemplary embodiments, and with reference to the figures, in which:

FIG. 1 shows a scene of the surrounding area recorded on the left by means of an NIR camera and on the right by means of an FIR camera,

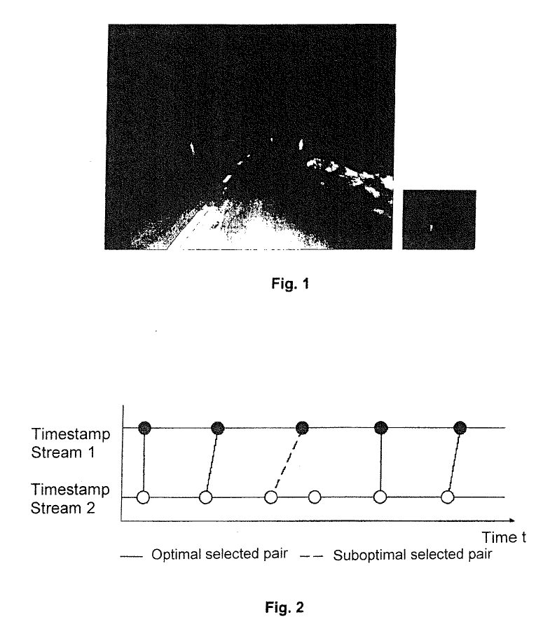

FIG. 2 shows a suboptimum association of two sensor signal streams

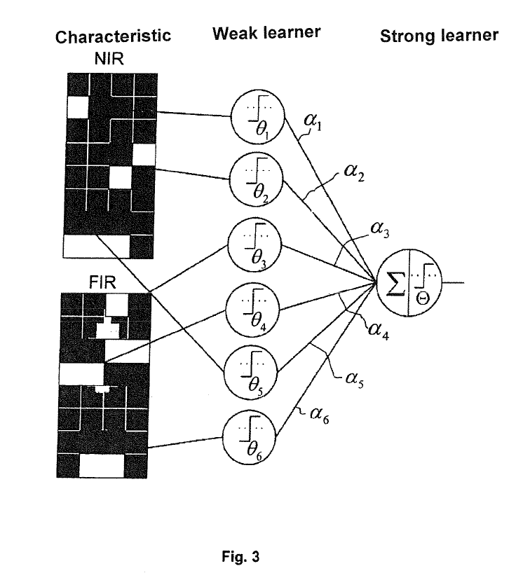

FIG. 3 shows feature formation in conjunction with a multistream detector,

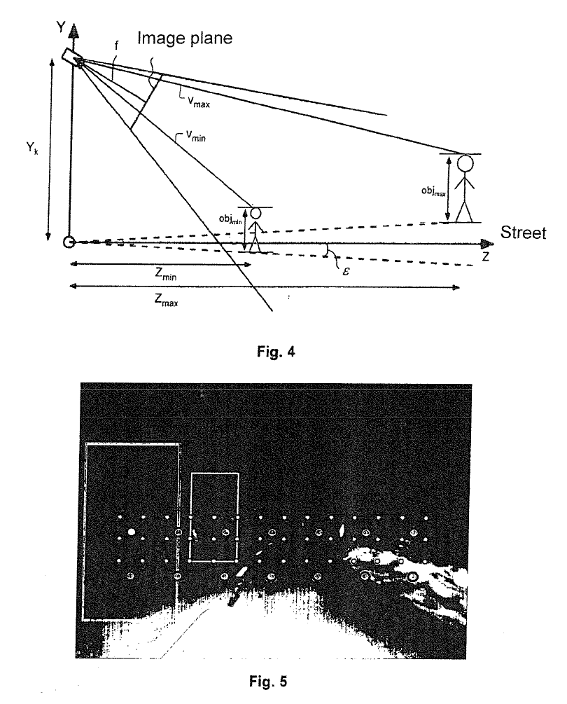

FIG. 4 shows the geometric definition of the search area

FIG. 5 shows a resultant hypothesis set for a single-stream hypothesis generator,

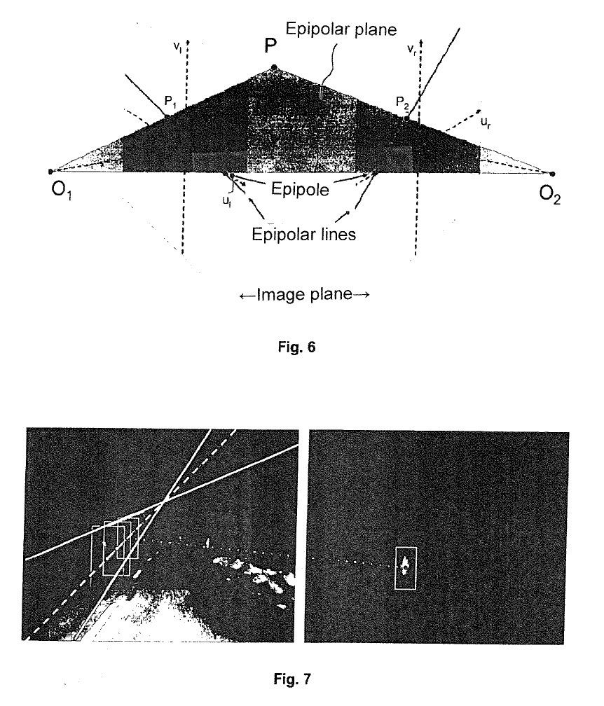

FIG. 6 shows the epipolar geometry of a two-camera system,

FIG. 7 shows the epipolar geometry using the example of pedestrian detection,

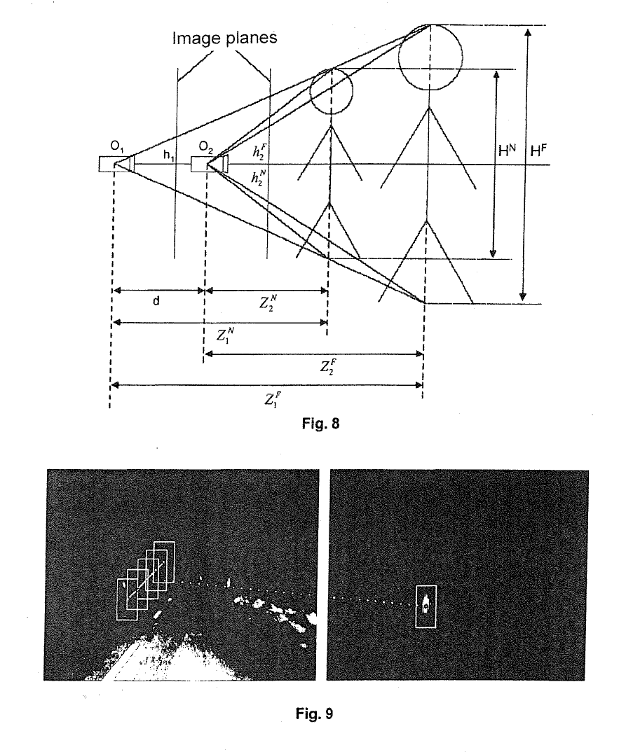

FIG. 8 shows the reason for scaling differences in correspondence search windows,

FIG. 9 shows correspondences which result in the NIR image for a search window in the FIR image,

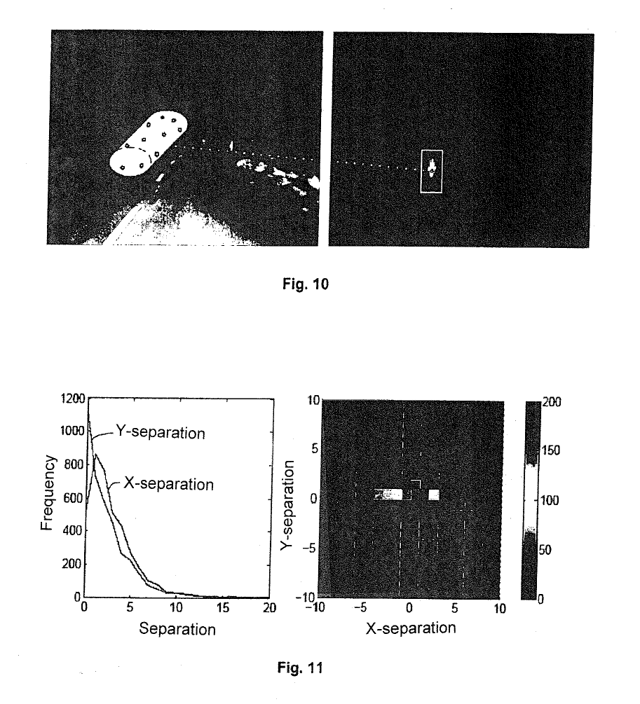

FIG. 10 shows the relaxation of the correspondence condition,

FIG. 11 shows correspondence errors between label and correspondence search windows,

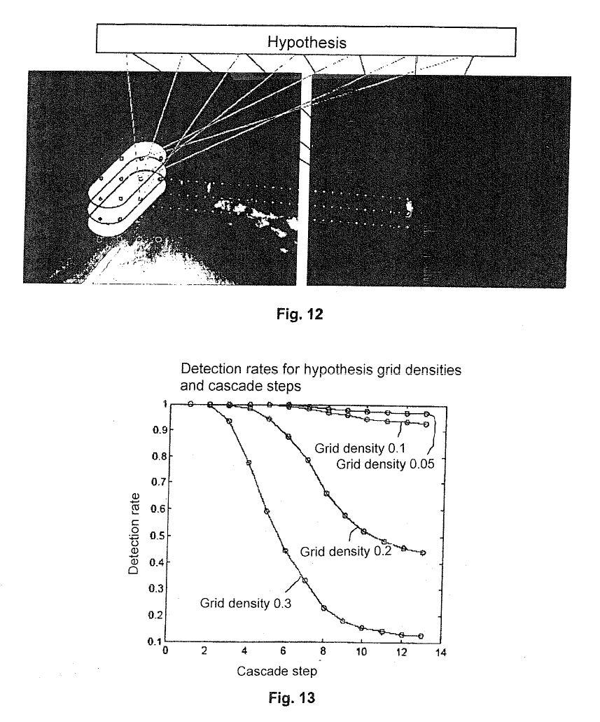

FIG. 12 shows how multistream hypotheses are created,

FIG. 13 shows a comparison of detection rates for a different grid width,

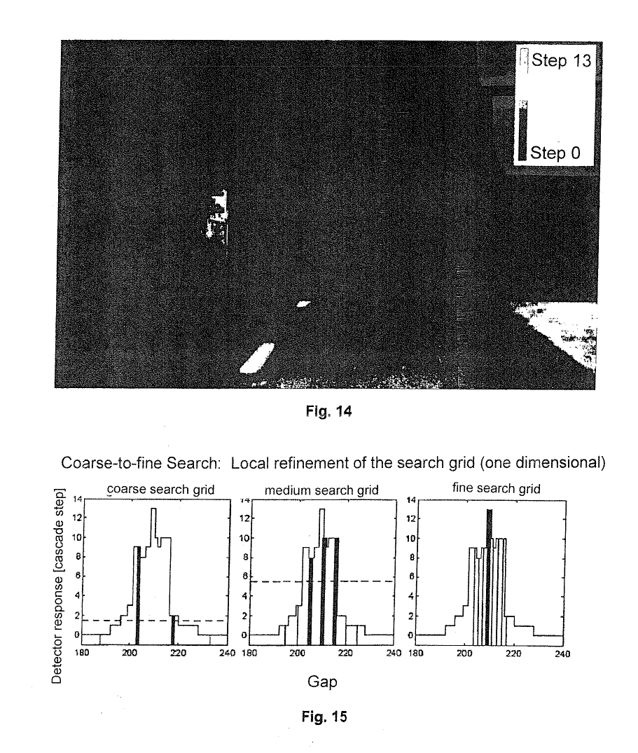

FIG. 14 shows the detector response as a function of the detection level achieved,

FIG. 15 shows a coarse-to-fine search in the one-dimensional case,

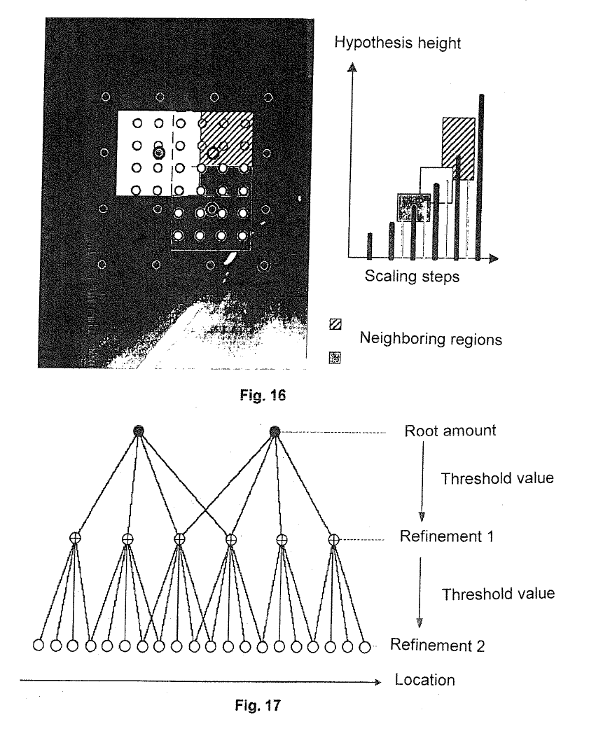

FIG. 16 shows, as an example, the neighborhood definition, and

FIG. 17 shows a hypothesis tree

FIG. 1 shows a scene of a surrounding area recorded on the left by means of an NIR camera and recorded on the right by means of an FIR camera. The two camera sensors and the intensity images recorded by them in this case differ to a major extent. The NIR image shown on the left-hand side has a high degree of variance as a function of the illumination conditions and surface characteristics. In contrast to this, the heat rays recorded by the FIR camera, and which are illustrated in the right-hand part of the figure, are virtually exclusively direct emissions from the objects. The natural heat of pedestrians in particular produces a pronounced signature in thermal imagers which is greatly emphasized against the background in ordinary road situations. However, this obvious advantage of the FIR sensor is contrasted by its resolution: in both the X direction and the Y direction, this is less by a factor of 4 than that of the NIR camera. This coarse sampling results in the loss of important high-frequency signal components. For example, a pedestrian at a distance of 50 m in the FIR image has a height of only 10 pixels. The quantization also differs in this case, and in this case although both cameras produce 12-bit gray-scale images, the dynamic range which is relevant for the detection task extends over 9 bits in the case of the NIR camera, but over only 6 bits in the case of the FIR camera. This results in the quantization error being greater by a factor of 8. Object structures can be seen well in the NIR camera image, and the image is in this case dependant on the lighting and surface structure, and has a high degree of intensity variance. In contrast to this, object structures are difficult to recognize in the FIR camera image, and the imaging is in this case dependant on emissions, with the pedestrian being clearly emphasized against the cold background. Because of the fact that both sensors have different types of advantages, to be precise in such a way that the strengths of the one are the weaknesses of the other, the use of these sensors jointly in the method according to the invention is particularly advantageous. In this case, the advantages of both sensors can be combined in one classifier, whose detection performance is considerably better than that of single-stream classifiers.

The expression sensor fusion refers to the use of a plurality of sensors and the production of a joint representation. The aim in this case is to improve the accuracy of the information obtained. This is characterized by the combination of measurement data in a perceptual system. The sensor integration, in contrast, relates to the use of different sensors for a plurality of task elements, for example image recognition for localization and a tactile sensor system for subsequent manipulation by means of actuators.

Fusion approaches can be subdivided into categories on the basis of their resultant representations. In this case, by way of example, a distinction is drawn between the four following fusion levels:
fusion at the signal level: in this case, the raw signals are considered directly. One example is the localization of acoustic sources on the basis of phase shifts.
Fusion at the pixel level: in contrast to the signal level, the spatial reference of pixels to objects in space is considered. Examples are extraction of depth information using stereo cameras, or else the calculation of the optical flow in image sequences.
Fusion at the feature level: in the case of fusion at the feature level, features are extracted from both sensors independently. These features are combined, for example, in a classifier or a localization method.
Fusion at the symbol level: symbolic representations are, for example, words or sentences during speech recognition. Grammar systems result in logical relationships between words. These can in turn control the interpretation of audible and visual signals.

A further form of fusion is classifier fusion. In this case, the results of a plurality of classifiers are combined. In this case, the data sources or the sensors are not necessarily different. The aim in this case is to reduce the classification error by redundancy. The critical factor is that the individual classifiers have errors which are as uncorrelated as possible. Some fusion methods of classifiers are, for example:
weighted majority decision: one simple principle is the majority decision, that is to say the selection of the class which has been output from most classifiers. Each classifier can be weighted corresponding to its reliability. Ideal weights can be determined by means of learnt data.
Bayes combination: a confusion matrix can be calculated for each classifier. This is a confusion matrix which indicates the frequency of all classifier results for each actual class. This allows conditional probabilities to be approximated for resultant classes. All the classifier are now mapped with the aid of the Bayes theorem onto probabilities for class associations. The maximum is then selected as the final result.
Stacked generalization: the idea of this approach is to use the classifier results as inputs and/or features of a further classifier. The further classifier may in this case be trained using the vector of the result and the label of the first classifier.

Possible fusion concepts for the detection of pedestrians are detector fusion and fusion at the feature level. Acceptable solutions already exist for the detection problem using just one sensor, so that combination by classifier fusion is possible. In the situation considered here, with two classifiers and a two-class problem, fusion by weighted majority decision or Bayes combination leads either to a single AND operation or to an OR operation on the individual detectors. The AND operation has the consequence that (for the same configuration), the number of detections and thus the detection rate can only be reduced. In the case of an OR operation, the false alarm rate cannot be better. The worth of the respective operations can be determined by the definition of the confusion matrices and analysis of the correlations. However, it is also possible to make a statement about the resultant complexity: in the case of the OR operation, the images from two streams must be sampled, and the complexity is at least the sum of the complexity of the two individual-stream detectors. As an alternative to an AND or OR operation, the detector result of the cascade classifier may be interpreted as a conclusion probability, in that the level reached and the last activation are mapped onto a detection probability. This makes it possible to define a decision function based on non-binary values. Another option is to use one classifier for awareness control and the other classifier for detection. The former should be configured such that the detection rate is high (at the expense of the false alarm rate). This may possibly reduce the amount of data of the detecting classifier, so that this can be classified more easily. Fusion at the feature level is feasible mainly because of the availability of boosting methods. The specific combination of features from both streams can therefore be carried out by the already used method, automated on the basis of the training data. The result represents approximately an optimum selection and weighting of the features from both streams. One advantage in this case is the expanded feature area. If specific subsets of the data can in each case be separated easily in only one of the individual-stream feature areas, then separation of all the data can be simplified by the combination. For example, the pedestrian silhouette can be seen well in the NIR image, while on the other hand, the contrast between the pedestrian and the background is imaged independently of the lighting in the FIR image. In practice, it has been found that the number of necessary features can be drastically reduced by fusion at the feature level.

The architecture of the multistream classifier that is used will be described in the following text. In order to extend the single-stream classifier to the multistream classifier, many parts of the classifier architecture need to be revised. One exception in this case is the core algorithm, for example AdaBoost, which need not necessarily be modified. Nevertheless, some of the implementation optimizations must be carried out, reducing the duration of an NIR training run with predetermined configuration process by several times. In this case, the complete table of the feature values is kept in the memory for all the examples. A further point is the optimizations for example generation. In practical use, it has thus been found possible to end training runs with 16 sequences in about 24 hours. Before this optimization, training with just three sequences lasted for two weeks. Further streams are integrated in the application in the course of a redesign of the implementations. The most modifications and innovations are in this case required for upgrading the hypothesis generator.

The major upgrades relating to data preprocessing will be described in the following text. The resultant detector is intended to be used in the form of a real-time system, and with live data from the two cameras. Labeled data is used for the training. A comprehensive database with sequences and labels is available for this purpose, which includes ordinary road scenes with pedestrians walking at the edge of the road, cars and cyclists. Although the two sensors that are used record about 25 images per second, the time sampling is, however, in this case carried out asynchronously, depending on the hardware, and the times of the two recordings are in this case independent. Because of fluctuations in the recording times, it is even normal for there to be a considerable difference between the number of images from the two cameras for one sequence. Use of the detector is impossible as soon as one feature is also not available. If, for example, the respective terms in the strong learner equation were to be replaced by zeros in the absence of features, the response would be undefined. This makes sequential processing of the individual images in the multistream data impossible, and synchronization of the sensor data streams is lengthened both for training and for use of a multistream detector. Image pairs must therefore be formed in this situation. Since the recording times of the images in a pair are not exactly the same, a different state of the surrounding area is in each case imaged. This means that the position of the vehicle and that of the pedestrian are in each case different. In order to minimize any influence of the dynamics of the surrounding area, the imaged pairs must be formed such that the differences between the two time stamps are minimal. Because of the different number of measurements per unit time mentioned, either images from one stream are used more than once, or images are omitted. There are two reasons in favor of the latter method: firstly, this minimizes the average time stamp difference, and secondly multiple use during on-line operation would lead to occasional peaks in the computation complexity. The following algorithm describes the data synchronization:

| | |
|---|---|
| 1 | Given: |
| 2 | |
| 3 | Image sequences Iₛ(i) for each stream s ∈ {1, 2} |
| 4 | |
| 5 | Time stamp tₛ(i) for all images for each stream s |
| 6 | |
| 7 | Expected time stamp difference E(tₛ(i + 1)−tₛ(i)) for each stream s |
| 8 | |
| 9 | Greatest expected time stamp difference discrepancy εₛ for each |
| | stream s |
| 10 | |
| 11 | Initialization: |
| 12 | |
| 13 | Start with the first images in the streams: |
| 14 | |
| 15 | i = 1 |
| 16 | j = 1 |
| 17 | P = 0 |
| 18 | |
| 19 | Algorithm: |
| 20 | |
| 21 | As long as the images I1(i) and I2(j) exist: |
| 22 | |
| 23 | $If \vert {t}_{1} ( i ) - {t}_{2} ( j ) \vert > {min}_{s} ( \frac{1}{2} \cdot ( E ( {t}_{s} ( i + 1 ) - {t}_{s} ( i ) ) + {ɛ}_{s} ) )$ |
| 24 | |
| 25 | If t₁(i) < t2(j) |
| 26 | i = i + 1 |
| 27 | Else |
| 28 | j = j + 1 |
| 29 | Else |
| 30 | |
| 31 | Form a pair (i,j): |
| 32 | |
| 33 | P = P ∪ (i,j) |
| 34 | i = i + 1 |
| 35 | j = j + 1 |
| 36 | |
| 37 | Result: |
| 38 | |
| 39 | Image pairs P |

In this case, εₛ, should be selected as a function of the distribution of tₛ(i+1)−tₛ(i) and should be about 3^{σ}. If εₛ is small, it is possible that some image pairs will not be found, while if εₛ is large, the expected time stamp difference will increase. The association rule corresponds to a greedy strategy and is therefore in general sub-optimal in terms of minimizing the mean time stamp difference. However, it can thus be used both in training and in on-line operation of the application. It is advantageously optimal for the situation in which V ar(tₛ(i+1)−tₛ(i))=0 and εₛ=0 ∀s.

By way of example, FIG. 2 shows a sub-optimum association of two sensor signal streams. In this case, this illustrates in particular the result of the association algorithm already described. In this example, the association is sub-optimum in terms of minimizing the mean time stamp difference. The association algorithm can be used in this form for the application, and it advantageously results in no delays caused by waiting for potential association candidates.

The concept of a search window plays a central role for feature formation, in particular for upgrading the detector for multisensor use, when a plurality of sensor signal streams are present. In the case of a single-stream detector, the localization of all the objects in an image comprises the examination of a set of hypotheses. In this case, a hypothesis represents a position and scaling of the object in the image. This results in the search window, that is to the say the image section which is used for feature calculation. In the multistream case, a hypothesis comprises a search window pair, that is to say in each case one search window in each stream. In this case, it should be noted that, for a single search window in the one stream, parallax problems can result in different combinations occurring with search windows in the other stream. This can result in a very large number of multistream hypotheses. Hypothesis generation for any desired camera arrangements will also be described further below. The classification is based on features from two search windows, as will be described with reference to FIG. 3. In this case, FIG. 3 shows feature formation in conjunction with a multistream detector. A multistream feature set corresponds to combination of the two feature sets which result for the single-stream detectors. A multistream feature is defined by a filter type, position, scaling and sensor stream. As a result of the high image resolution, smaller filters can be used in the NIR search window than in the FIR search window. The number of NIR features is therefore greater than the number of FIR features. In this exemplary embodiment, approximately 7000 NIR features and approximately 3000 FIR features were used.

New training examples are advantageously selected continuously during the training process. Before training by means of each classifier level, a new example set is produced using all the already trained steps. In multistream training, the training examples, like the hypotheses, comprise one search window in each stream. Positive examples result from labels which are present in each stream. In this case, an association problem arises in conjunction with automatically generated negative examples: the randomly selected search windows must be consistent with the projection geometry of the camera system, such that training examples match the multistream hypotheses of the subsequent application. In order to achieve this, a specific hypothesis generator is used, and will be described in detail in the following text, for determination of the negative examples. Instead of selecting the position and size of the search window independently and randomly from negative examples as in the past, random access is now made to a hypothesis set. In this case, in addition to consistent search window pairs, the hypothesis set has a more intelligent distribution of the hypotheses in the image, based on world models. This hypothesis generator can also be used for single-stream training. In this case, the negative examples are determined using the same search strategy which will later be used for application of the detector to hypothesis generation. The example set for multistream training therefore comprises positive and negative examples which in turn each include one search window in both streams. By way of example, AdaBoost is used for training, with all the features of all the examples being calculated. In comparison to single-stream training, only the number of features changes for feature selection, since they are abstracted on the basis of their definition and the multistream data source associated therewith.

The architecture of a multistream data application is very similar to that of a single-stream detector. The modifications required to this system are, on the one hand, adaptations for general handling of a plurality of sensor signal streams, therefore requiring changes at virtually all points in the implementation. On the other hand, the hypothesis generator is extended. A correspondence condition for search windows in both streams is required for generation of multistream hypotheses, and is based on world modules and camera models. A multistream camera calibration must therefore be integrated in the hypothesis generation. The brute-force search in the hypothesis area used for single-stream detectors can admittedly be transferred to multistream detectors, but this has frequently been found to be too inefficient. In this case, the search area is enlarged considerably, and the number of hypotheses is multiplied. In order nevertheless to retain a real-time capability, the hypothesis set must once again be reduced in size, and more intelligent search strategies are required. The fusion approach which is followed in conjunction with this exemplary embodiment corresponds to fusion at the feature level. AdaBoost is in this case used to select a combination of features from both streams. Other methods could also be used here for feature selection and fusion. The required changes to the detector comprise an extended feature set, synchronization of the data and production of a hypothesis set which also takes account of geometric relationships between the camera models.

The derivation of a correspondence rule, search area sampling and further optimizations that result in improvements will be described in the following text. Individual search windows are evaluated successively using the trained single-stream cascade classifier. As a result, the classifier produces a statement as to whether an object has been detected at precisely this position and with precisely this scaling. Pedestrians may appear at different positions with different scalings in each image. A large set of positions and hypotheses must therefore be checked in each image when using the classifier as a detector. This hypothesis set can be reduced by undersampling and search area constraints. This makes it possible to reduce the computation effort without adversely affecting the detection performance. Hypothesis generators for single-stream applications are already known for this purpose from the prior art. In the case of the multistream detector proposed in conjunction with this exemplary embodiment, hypotheses are defined via a set window pair, that is to say via a search window in each stream. Although the search windows can be produced in both streams by means of two single-stream hypothesis generators the logic operation to form the multistream hypothesis set is, however, not trivial because of the parallax. The association of two search windows from different streams to form a multistream hypothesis must in this case satisfy specific geometric conditions. In order to achieve robustness in terms of calibration errors and dynamic influences, relaxations of these geometric correspondence conditions are also introduced. Finally, one specific sampling and association strategy is selected. This results in very many more hypotheses than in the case of single-stream detectors. In order to ensure the real-time capability of the multistream detector further optimization strategies will be described in the following text, also including a highly effective method for hypothesis reduction by means of dynamic local control of the hypothesis density, which method can also be used equally well in conjunction with single-stream detectors. The simplest search strategy for finding objects at all the positions in the image is pixel-by-pixel sampling of the entire image in all the possible search window sizes. For an image with 640×480 pixels, this results in a hypothesis set comprising about 64 million elements. This hypothesis set is referred to in the following text as the complete search area of the single-stream detector. The number of hypotheses to be examined can be reduced in a particularly advantageous manner to about 320,000 with the aid of an area restriction, which will be described in the following text, based on a simple world model, and scaling-dependant undersampling of the search area. The basis of the area restriction is on the one hand the so-called “ground plane assumption”, the assumption that the world is flat, with the objects to be detected and the vehicle being located on the same plane. On the other hand, a unique position in three dimensions can be derived from the object size in the image and based on an assumption relating to the real object size. In consequence, all the hypotheses for a scaling in the image lie on a horizontal straight line. Both assumptions, that is to say the “ground plane assumption” and that relating to a fixed real object size are in general not applicable. For this reason, the restrictions are relaxed such that a certain tolerance band is permitted for the object position and for its size in space, and this situation is illustrated in FIG. 4. The relaxation of the “ground plane assumption” is in this case indicated by an angle ε which, for example, is 1° in this exemplary embodiment. This also compensates for orientation errors in the camera model which can occur, for example, as a result of pitching movements of the vehicle. In addition to the area restriction described, the number of hypotheses to be examined is reduced further by scaling-dependant undersampling. The stepwidth of the sampling in the u direction and v direction in FIG. 4 is in this case selected to be proportional to the hypothesis height, that is to say to the scaling, and in this example is about 5% of the hypothesis height. The search window heights themselves result from a series of scalings, which each become greater by 5%, starting with 25 pixels in the NIR image (8 pixels in the FIR image). This type of quantization may be motivated by a characteristic of the detector, specifically the fact that, with the size scaling of the features, the fuzziness of their localization in the image also increases, as is the case, for example, with a hair wavelet or similar filters. The features are in this case defined in a fixed grid, and are also scaled corresponding to the size of the hypothesis. In this case, the described hypothesis generation process results in the 64 million hypotheses in the entire search area in the NIR image being reduced to 320 000. Because of the low image resolution, there are 50 000 hypotheses in the FIR image, and in this context reference is also made to FIG. 5. A transformation between image coordinates and world coordinates is required in order to take account of the restrictions defined in three-dimensional space. This is based on the intrinsic and extrinsic camera parameters determined by the calibration. The geometric relationships for the projection of a 3D point onto the image plane would be familiar to a person skilled in the art in the field of image evaluation. In this exemplary embodiment, a pinhole camera model is used, because of the small amount of distortion in the two cameras.

FIG. 4 illustrates the geometric definition of the search area. In this case, this shows the search area which results for a fixed scaling. An upper limit and a lower limit are calculated for the upper search window edge in the image. The limits (vₘᵢₙ and vₘₐₓ) are reached when the object on the one hand with the smallest expected object size (objₘᵢₙ) and on the other hand with the largest expected object size (objₘₐₓ) are projected onto the image plane. In this case, the distance (zₘᵢₙ and zₘₐₓ) is selected so as to achieve the correct scaling in the image. Because of the relaxed restriction to the ground plane assumption, the spatial position is located between the planes shown by dashed lines. The smallest and the largest object are in this case appropriately shifted upwards and downwards for calculation of the limits.

FIG. 5 shows the resultant hypothesis set for the single-stream hypothesis generator. In this case, search windows are generated with an arrangement like a square grid. Different scalings result in different square grids with matched grid intervals and their own error restrictions. In order to illustrate this clearly, FIG. 5 shows only one search window for each scaling and the center points of all the other hypotheses. The illustration is by way of example, and large scaling and position stepwidths have been chosen in this case.

Multistream hypotheses are therefore obtained by suitable pair formation from the single-stream hypotheses. The epipolar geometry is in this case the basis for pair formation, by which means the geometric relationships are described. FIG. 6 shows the epipolar geometry of a two-camera system. The epipolar geometry describes the set of possible correspondence points for one point on an image plane. Epipolar lines and an epipolar plane can be constructed for each point p in the image. The possible correspondence points for points on an epipolar line in an image are in this case precisely those on the corresponding epipolar line of the other image plane. In particular, FIG. 6 shows the geometry of a multicamera system with two cameras arranged as required with the centers O₁εR³ and O₂εR³ and an undefined point PεR³. O₁, O₂ and P in this case cover the so-called epipolar plane. This intersects the image planes in the epipolar lines. The epipoles are the intersections of the image planes with the straight line O₁O₂. O₁O₂ is contained on all the epipolar planes of all the possible points P. All the epipolar lines that occur therefore intersect at the respective epipole. The epipolar lines have the following significance for finding correspondence: epipolar lines and one epipolar plane can be constructed for each point p in the image. The possible correspondence points for points on an epipolar line in an image are precisely the same as those on the corresponding epipolar line on the other image plane.

It is now assumed that the point PεR³ is a point in space. P1, P2εR3 is essentially the representation of P in the camera coordinate systems with the origin O₁ and O₂, respectively. This results in a rotation matrix RεR^{3×3} and a translation vector TεR³ for which:

P₂=R(P₁−T). (5.1)

R and T are in this case uniquely defined by the relative extrinsic parameters of the camera system. P₁, T and P₁−T are coplanar, that is to say:

(P₁−T)^{T}·(T×P₁)=0. (5.2)

Equation (5.1) and the orthonormality of the rotation matrix results in:

0=(P₁−T)^{T}(T×P₁)^{(5.1)}=(R⁻¹P₂)^{T}(T×P₁)=(R^{T}P₂)^{T}(T×P₁). (5.3)

The cross-product can now be rewritten as a scalar product:

$$T \times {P}_{1} = S \cdot {P}_{1} mit S = ( \begin{matrix}0 & - {T}_{Z} & {T}_{Y} \\ {T}_{Z} & 0 & - {T}_{X} \\ - {T}_{Y} & {T}_{X} & 0\end{matrix} ) . \qquad ( 5.4 )$$

Therefore, from equation (5.3)

0=(R^{T}P₂)^{T}(SP₁)=(P₂^{T}R)(SP₁)=P₂^{T}(RS)P₁=P₂^{T}EP₁, (5.5)

here E:=RS, the essential matrix. A relationship is now produced between P₁ and P₂. If this is projected by means of

$${p}_{1} = \frac{{f}_{1}}{{Z}_{1}} {P}_{1} and {p}_{2} = \frac{{f}_{2}}{{Z}_{2}} {P}_{2}$$

then this results in:

$$0 = {P}_{2}^{T} {EP}_{1} = \frac{{Z}_{2}}{{f}_{2}} {p}_{2}^{T} E = \frac{{Z}_{1}}{{f}_{1}} {p}_{1}^{T} = {p}_{2}^{T} {Ep}_{1}^{T} . \qquad ( 5.6 )$$

In this case, f_{1,2} is the focal length and Z_{1,2} is the Z component of P_{1,2}. The set of all possible pixels p₂ in the second image which correspond with a point p₁ in the first image can therefore now be precisely that for which the equation (5.6) is satisfied. Using this correspondence condition for individual pixels, consistent search window pairs can now be formed from the single-stream hypotheses as follows: the aspect ratio of the search windows is preferably fixed by definition, that is to say a search window can be described uniquely by the center points of the upper and lower edges. With the correspondence condition for pixels, two epipolar lines thus result in the image of the second camera for the possible center points of the upper and lower edges of all the corresponding search windows, as is illustrated, for example, in FIG. 7. FIG. 7 shows the epipolar geometry using the example of pedestrian detection. In this case, a search window is projected ambiguously from the image from the right-hand camera into that from the left-hand camera. The correspondence search windows in this case result from the epipolar lines of the center points of the search window lower and upper edges. In this case, the figure is only illustrative, for clarity reasons. The set of possible search window pairs is intended to include all those search window pairs which describe objects with a realistic size. If the back-projection of the objects is calculated into the space, the position and size of the object can be determined by triangulation. The area of the epipolar lines is then reduced to correspondences with a valid object size, as is illustrated by the dashed line in FIG. 7.

The optimization of the correspondence area will now be described, resulting a plurality of correspondence search windows with different scaling for the projection of a search window from one sensor stream into the other sensor stream. This scaling difference disappears, however, if the camera positions and alignments are the same, except for a lateral offset. Only an offset d between the centers O₁ and O₂ in the longitudinal direction of the camera system is therefore relevant for scaling, as is illustrated in FIG. 8. The orientation difference between the two cameras is negligible in this example. In this case, in particular, FIG. 8 shows the reason for the scaling differences which result in the correspondence search windows, and with a plurality of correspondence search windows with different scaling resulting when a search window is projected from the first sensor stream into the second sensor stream. In this case, the geometric relationship between the camera arrangement, object sizes and scaling differences is illustrated in detail.

A fixed search window size h₁ is preset in the first image. The ratio

$$\frac{{h}_{2}^{min}}{{h}_{2}^{max}}$$

will be examined in the following text, with h₂^{min} and h₂^{max} respectively being the minimum and maximum scaling that occurs in the corresponding search windows in the second sensor stream with respect to the search window h₁ in the first sensor stream. H^{min}=1 m is assumed to be the height of a pedestrian nearby, and H^{max}=2 m is assumed to be the height of a pedestrian a long distance away, with only pedestrians having a minimum size of 1 m and a maximum size of 2 m being considered in this case. Both pedestrians are assumed to be sufficiently far away that they have the height h₁ in the image of the first camera.

If it also assumed that Z₁^{min}, Z₁^{max}, Z₂^{min} and z₂^{max} are the object separations between the two objects with regard to the two cameras, then it follows that:

$$\begin{matrix}{Z}_{2}^{min , max} = {Z}_{1}^{min , max} - d & ( 5.7 ) \\ and & \\ {h}_{1} = \frac{{f}_{1}}{{Z}_{1}^{min}} {H}^{min} = \frac{{f}_{1}}{{Z}_{1}^{max}} {H}^{max} {Z}_{1}^{max} = \frac{{H}^{max}}{{H}^{min}} {Z}_{1}^{min} . & ( 5.8 )\end{matrix}$$

The scaling ratio is then given by:

$$\begin{matrix}\frac{{h}_{2}^{max}}{{h}_{2}^{min}} = \frac{\frac{{f}_{2}}{{Z}_{2}^{min}} {H}^{min}}{\frac{{f}_{2}}{{Z}_{2}^{max}} {H}^{max}} \\ = \frac{{Z}_{2}^{max}}{{Z}_{2}^{min}} \cdot \frac{{H}^{min}}{{H}^{max}} \\ {=}^{( 5.7 )} \frac{{Z}_{1}^{max} - d}{{Z}_{1}^{min} - d} \cdot \frac{{H}^{min}}{{H}^{max}} \\ {=}^{( 5.8 )} \frac{\frac{{H}^{max}}{{H}^{min}} {Z}_{1}^{min} - d}{{Z}_{1}^{min} - d} \cdot \frac{{H}^{min}}{{H}^{max}} .\end{matrix} \qquad ( 5.9 )$$

For long ranges, the scaling ratio tends to unity. When the classifier is being used as an early warning system in normal road scenarios, the choice of Z₁^{min} can be restricted to values of more than 20 m. In the experimental carrier, the offset between the cameras is about 2 m. Together with the values proposed above for pedestrian sizes, this means that:

$$\frac{{h}_{2}^{max}}{{h}_{2}^{min}} \leq 1.055$$

The correspondence area for a search window in the first stream, that is to say the set of the corresponding search windows in the second stream, can therefore be simplified as follows: the scaling of all the corresponding search windows is standardized. The scaling h₂ which is used for all the correspondences is the mean value of the minimum and maximum scaling that occurs:

$${h}_{2} = \frac{{h}_{2}^{min} + {h}_{2}^{max}}{2} . \qquad ( 5.10 )$$

The scaling error that this results in is in this case at most 2.75%. FIG. 9 shows resultant correspondences in the NIR image for a search window in the FIR image. In this case, a standardized scaling is used for all the corresponding search windows.

In actual applications, the pair-formation process described above is frequently inadequate to produce multistream hypotheses in order to model the correspondence error. Furthermore, the following factors are also taken into account in a manner which results in an improvement:
Errors in the extrinsic and intrinsic camera parameters, caused by measurement errors during camera calibration.
Influences of the dynamics of the surrounding area.

There is therefore an unknown error in the camera model. This results in fuzziness both for the position and for the scaling of the correlating search windows, and this is referred to in the following text as the correspondence error. The scaling error is ignored, for the following reasons: firstly, the influence of the dynamics on the scaling is very small when the object is at least 20 m away. Secondly, a considerable amount of insensitivity can be seen and the detector response, relating to the exactness of the hypothesis scaling. This can be seen on the basis of multiple detections whose center points admittedly vary scarcely at all, although the scalings in this case vary severely. In order to compensate for the translative error, a relaxation is introduced in the correspondence condition. For this purpose, a tolerance band is defined for the position of the correlating search windows. An elliptical tolerance band with the radii eₓ and e_{y} is defined for each of these correspondences in the image, within which band further correspondences occur, as is illustrated in FIG. 10. In this case, the correspondence error is identical for each search window scaling. The resultant tolerance band is therefore chosen to be the same for each scaling.

FIG. 10 shows the relaxation of the correspondence condition. The positions of the correlating search windows are in this case not just restricted to a path. They can now be located in an elliptical area around this path. In this case, only the center points of the search windows are shown in the NIR image. Labeled data is used to determine the radii with respect to this correspondence error. The radii of the elliptical tolerance band are determined as follows:
The search windows in both streams are determined for each multistream label.
All the possible correspondence search windows in the second stream are calculated for the respective search window in the first stream. A non-relaxed correspondence condition is used in this case.
The correspondence search window which comes closest to the label search window in the second stream is used for error determination. The proximity of two search windows may in this case be defined either by the coverage, in particular by the ratio of the intersection area of two rectangles to their combined error (also referred to as coverage) or by the distance between the search window center points. The latter definition has been chosen in this exemplary embodiment, since this means that the scaling error, which is not critical for the detector response, is ignored.
The distance in the X direction and Y direction between the label search window and the closest correspondence search window is determined for all the labels. This results in a probability distribution for the X separations and Y separations. A histogram relating to the separation in the X direction and Y direction is illustrated in FIG. 11.
The radii eₓ and e_{y} are now derived from the distribution of the separations. eₓ=2^{σ}x and e_{y}=2^{σ}y was chosen in this work. The next step after the definition of the correspondence area for a search window is search area scanning. As in the case of single-stream undersampling, the number of hypotheses is also intended to be minimized in this case, with the detection performance being reduced as little as possible.

FIG. 11 shows the correspondence error between label and correspondence search windows. The illustrated correspondence error is in this case the shortest pixel distance between a label search window and the correspondence search windows of the corresponding label, that is to say the projected label of the other sensor signal stream. In the case of the illustrated measurement, FIR labels are projected into the NIR image, and a histogram is formed over the separations between the search window center points.

The method for search area sampling is carried out as follows: single-stream hypotheses, that is to say search windows, are scattered with the single-stream hypothesis generator in both streams. In this case, the resultant scaling steps must be matched to one another, with the scalings in the first stream being determined by the hypothesis generator. The correspondence area of a prototypical search window is then defined for each of these scaling steps. The scalings of the second stream result from the scalings of the correspondence areas of all of the prototypical search windows. This results in the same number of scaling steps in both streams. Search window pairs are now formed, thus resulting in the multistream hypotheses. One of the two streams can then be selected in order to determine the respective correspondence area in the other stream, for each search window. All the search windows of the second stream which have the correct scaling and are located within this area are used together with the fixed search window from the first stream for pair formation, as is illustrated in FIG. 12. In this case, FIG. 12 shows the resultant multistream hypotheses. In this case, three search windows are shown in the FIR image, and their corresponding areas in the NIR image. The pairs are formed using the search windows scattered by single-stream hypothesis generators. In this case, one multistream hypothesis corresponds to one search window pair.

If position and scaling stepwidths of 5% of the search window height are selected for the internally used single-stream hypothesis generators, then this results in approximately 400 000 single-stream hypotheses in the NIR image, and approximately 50 000 in the FIR image. However, this results in about 1.2 million multistream hypotheses. It has been possible to achieve a processing rate of 2 images per second in practical use. In order to ensure the real-time capability of the application, further optimizations are proposed in the following text. On the one hand, a so-called weak-learner cache is described, which reduces the number of feature calculations required. Furthermore, a method is proposed for dynamic reduction of the hypothesis set, referred to in the following text as a multigrid hypothesis tree. The third optimization, which is referred to as backtracking, reduces unnecessary effort in conjunction with multiple detections, in the case of detection.

The evaluation of a plurality of multistream hypotheses which jointly have one search window leads to weak learners being calculated more than once using the same data. A caching method is now used in order to avoid all the redundant calculations. In this case, partial sums of the strong-learner calculation are stored in tables for each search window in both streams and for each strong learner. A strong learner H^{k} in the cascade level k is defined by:

$${H}^{k} ( x ) = \{ \begin{matrix}1 & ⋮ & {S}^{k} ( x ) \geq {Θ}^{k} \\ - 1 & ⋮ & else\end{matrix} where {S}^{k} ( x ) = {\sum }_{t = 1}^{T} {α}_{t}^{k} {h}_{t}^{k} ( x ) \qquad ( 5.11 )$$

with the weak learners hₜ^{k}ε{−1, 1} and hypothesis x. S^{k}(X) can be split into two sums which contain only weak learners with features of one stream:

$${S}^{k} ( x ) = {\sum }_{t = 1}^{T} {α}_{t}^{k} {h}_{t}^{k} ( x ) = {\sum }_{t ∈ {W}_{1}^{k}}^{ } {α}_{t}^{k} {h}_{t}^{k} ( x ) + {\sum }_{t ∈ {W}_{2}^{k}}^{ } {α}_{t}^{k} {h}_{t}^{k} ( x ) = : {S}_{1}^{k} ( x ) + {S}_{2}^{k} ( x ) , \\ where {W}_{s}^{k} = \{ t \vert {h}_{t}^{k} is a weak learner in the stream s \} .$$

(5.12)

If a plurality of hypotheses xⁱ in a stream s have the same search window then this sum sₛ^{k} (xᵢ) is the same for all xᵢ in each step k for the stream s. The result is preferably temporarily stored, and is used repeatedly. If values that have already been calculated can be used for a strong learner calculation, this reduces the complexity, in a manner which results in an improvement, to a sum operation and a threshold value operation. With regard to the size of the tables, this results in 12.5 million entries in this exemplary embodiment for a total of 500 000 search windows sand 25 cascade levels. In this case, 100 MB of memory is required using 64-bit floating-point numbers. The number of feature calculations can be considered both with and without a weak-learner cache for a complexity estimate. In the former case, the number of hypotheses per image and the number of all of the features are the critical factors. The number of hypotheses can be estimated by the number of search windows Rₛ in the streams s to be O(R1·R2). The factor concealed in the O notation is in this case, however, very small, since the correspondence area is smaller in comparison to the total image area. The number of calculated features is then in the worst case O(R1·R2·(M1+M2)), where Ms is the number of features in each stream s. In the second case, each feature in each search window is calculated at most once per image. The number of calculated features is therefore at most O(R1·M1+R2·M2). In the worst case, the complexity is reduced by a factor min(R1,R2). A complexity analysis for the average case is in contrast more complex since the relationship between the mean number of calculated features per hypothesis or search window in the first case and in the second case is non-linear.

Statements relating to the multigrid hypothesis tree now follow. The search area of the multistream detector was in this case recorded using two single-stream hypothesis generators and a relaxed correspondence relationship. However, in this case, it is difficult to find an optimum configuration, specifically to find the suitable sampling stepwidths. On the one hand, they have the major influence on the detection performance, and on the other hand on the resultant computation complexity. In a practical trial, it was possible to find acceptable compromises for the single-stream detectors, which made it possible to ensure a real-time capability in the FIR situation, because of the poorer image resolution, although this was not possible with the hardware being used in the NIR case. The performance of the trial computer being used was also inadequate when using a fusion detector with a weak-learner cache, and in complex scenes led to longer reaction times. However, these problems can, of course, be solved by more powerful hardware.

Those configurations of the hypothesis generator and of the detector were tested in practical use. During this process, a plurality of search group densities and various step restrictions were evaluated. It was found that each pedestrian to be detected was recognized even with the first steps of the detector, even with very coarse sampling. In this case, the rear cascade steps were switched off successively, leading to a high force alarm rate. The measured values recorded during practical use are shown in FIG. 13. Starting with the finest grid density, the number of hypotheses was: about 1 200 000, 200 000, 7000 and 2000.

In this case, FIG. 13 shows the comparison of the detection rates for various grid widths, with four different hypothesis grid densities being compared. The detection rate of a fusion detector is plotted against the number of stages used for each grid width. The detection rate is defined by the number of pedestrians found divided by the total number of pedestrians. The reason for the phenomenon that occurred is the following characteristic of the detector: the detector response, that is to say the cascade step reached, is a maximum for a hypothesis which is positioned exactly on a pedestrian. If the hypothesis is now moved step-by-step away from the pedestrian, the detector result does not fall abruptly to zero, but an area exists in which the detector result varies widely, and has a tendency to fall. This behavior of the cascade detector is referred to in the following text as the characteristic detector response. An experiment in which an image is sampled in pixel steps is shown in FIG. 14. In this case, a multistream detector and hypotheses with fixed scaling are used. The area for which the detector response falls with a delay can be seen well. Furthermore, it was found that the detector has similar characteristics in an experiment with a fixed position and varying scaling. The detection performance of the shortened detector when applied to a coarse hypothesis grid can thus be explained, because the “heat area” for a pedestrian is larger than for lower levels.

FIG. 14 shows the detector response as a function of the detection level reached. In this case, a multistream detector is applied to a hypothesis set using a scaling with a pixel-accuracy grid. The last cascade reached is shown for each hypothesis, at its center point. No training examples slightly offset with respect to a label are used during training. Only exact positive examples are used, as well as negative examples which are a long way away from each positive example. The behavior of the detector is therefore undefined in the case of hypotheses which are slightly offset with respect to an object. The characteristic detector response is thus examined experimentally for each detector. The central concept to reduce the number of hypotheses is in this case a coarse-to-fine search, with each image being searched in the first step using a hypothesis set with coarse resolution. Further hypotheses with a higher density in the image are now scattered, as a function of the detector result. In addition, the local neighborhood of those hypotheses which lead to the supposition that there is an object in their vicinity is searched through. The detector behavior as described above makes it possible to use the number of steps achieved as the criteria for refinement of the search. The local vicinity of the new hypotheses can then be searched through once again using the same principle until the finest hypothesis grid is reached. For each refinement step, a threshold value is used with which the cascade step reached for each hypothesis is compared.

FIG. 15 shows a coarse-to-fine search in the single-dimensional case. An image line from the image shown in FIG. 14 is used for this purpose, and is illustrated in the form of a function in FIG. 15. The steps of the search method can be seen from left to right. The hypothesis results are shown vertically, and the threshold values for local refinement are shown horizontally. The experiment described initially can be used for threshold value definition. The detection rate of each grid density is virtually identical for the first steps of the detector. The maximum step for which the relevant grid density still has virtually the same detection rate as the maximum achievable is selected as the threshold value. A detection rate Dₖ^{L} is required for the threshold value step k of a grid density L, such that

$$\frac{{D}_{k}^{L}}{{D}_{k}^{H}} \geq α \cdot {D}_{k}^{H} .$$

Dₖ^{H} in this case denotes the detection rate of the finest grid density H in step k. If n is the number of refinements, then the detection rate for the last step K of the detector is:

D_{K}=αⁿ·D_{K}^{H}

In this example, values between 0.98 and 0.999 are mainly suitable for α.

The hypothesis area is considered for the definition of neighborhood. The hypothesis area is now not one-dimensional but, in the case of the single-stream detector, is three-dimensional, or six-dimensional in the case of a fusion detector. The problem of step-by-step refinement in all dimensions is solved by the hypothesis generator. In this case, there are two possible ways to define neighborhood, the second of which is used in this exemplary embodiment. On the one hand, a minimum value can be defined for the coverage of two adjacent search windows. However, in this case, it is not clear how the minimum value can be selected since gaps can occur in the refined hypothesis sets, that is to say areas which are not close enough to any hypothesis in the coarse hypothesis set. Different threshold values must therefore be defined for each grid density. On the other hand, the neighborhood can be defined by a modified chequerboard distance. This avoids the gaps that have been mentioned and it is possible to define a standard threshold value for all grid densities. The chequerboard distance is defined by:

$$dist ( {p}_{1} , {p}_{2} ) = max ( \vert {p}_{1 , x} - {p}_{2 , x} \vert , \vert {p}_{1 , y} - {p}_{2 , y} \vert ) where {p}_{1} , {p}_{2} ∈ {2}^{} . \qquad ( 5.13 )$$

The grid density for a stream is defined by rₓ, r_{y}, rₕεR. The grid intervals for a search window height h are then rₓ·h in the X direction and r_{y}·h in the Y direction. The next larger search window height for a search window height h₁ is h₂=h₁·(1+rh). The neighborhood criterion for a search window in the position s₁εR² and with a search window height of h₁ for a search window s₂εR² of a fine hypothesis set with a height h₂ is defined by a scalar δ:

$$max ( \frac{\vert {s}_{1 , x} - {s}_{2 , x} \vert}{{r}_{x} \cdot {h}_{1}} , \frac{\vert {s}_{1 , y} - {s}_{2 , y} \vert}{{r}_{y} \cdot {h}_{1}} ) \leq δ ⋀ {h}_{2} ∈ [ {{h}_{1} ( 1 + {r}_{h} )}^{- δ} , {{h}_{1} ( 1 + {r}_{h} )}^{+ δ} ] . \qquad ( 5.14 )$$

The resultant interval limits are shown in FIG. 16. In the multistream case, there is one three-dimensional neighborhood criterion in each stream. The neighborhood condition must be satisfied in both streams for adjacent multistream hypotheses. If one selects rₓ=r_{y} and δ=0.5, then all the neighborhood areas are disjunct, except for the edges. If the stepwidths rₓ and r_{y} are successively halved for the refinement hypothesis sets and the hypothesis to be added for precisely at the boundaries of the neighborhood areas, this value is worthwhile for δ, since the finer hypotheses are linked to all the adjacent coarser hypotheses. However, this is not true if the refined hypothesis sets have undefined grid intervals. It is then necessary to ensure by selection of δ<0.5 that the neighborhood areas of adjacent hypotheses in the coarse set overlap, and that the hypotheses in the fine grid are associated with a plurality of hypotheses in the coarse grid. The required value for δ must be determined experimentally, that is to say it must be matched to the characteristic detector response.

FIG. 16 shows the neighborhood definition, the neighborhood is shown for three of the hypotheses of the same scaling level, with three different scalings and their resultant scaling neighborhood also being shown on the right. In this case, δ was chosen to be 0.75.

The production of the refined hypotheses during use was too time-consuming and can be carried out just as well as a preprocessing step. The refined hypothesis sets are all generated by means of the hypothesis generator. The hypothesis set is first of all generated for each refinement level. The hypotheses are then linked with the neighborhood criterion, with each hypothesis being compared with each hypothesis in the next finer hypothesis set. If these are close, they are linked. This results in a tree-like structure whose roots correspond to the hypotheses in the coarsest level. The edges in FIG. 17 represent the calculated neighborhood relationships. Since a certain amount of search effort is associated with the generation of the hypothesis tree, the calculations required for this purpose are preferably carried out using a separate tool, and are stored in the form of a file.

FIG. 17 shows the resultant hypothesis tree. The hypothesis tree/search tree in this case has a plurality of roots and is searched through from the roots up to the leaf level, provided that the detection result of a node is greater than the threshold value. The hypothesis tree is run through during the processing of an image (or an image pair in the case of a multistream detector). The tree is searched through using a depth or width search, starting with the first tree root. The hypothesis of the root is in this case evaluated. As long as the corresponding threshold value is exceeded, the process climbs down the tree and the respective child node hypotheses are examined. The search is then continued with the next tree root. The depth search is most effective together with the backtracking method described in the following text. Since nodes may have a plurality of father nodes, it is necessary to ensure that each node is examined only once. Use of a multigrid hypothesis tree in this case results, in a manner which results in an improvement, in a reduction in the number of hypotheses, and this affects the detection performance.

The number of multiple detections in the case of the multistream detector and in the case of the FIR detector is very high. Multiple detections therefore have a major influence on the computation time since they pass through the entire cascade. A so-called backtracking method is therefore used. In this case, a change in the search strategy makes it possible to avoid a large proportion of the multiple detections, with the search in the hypothesis tree being interrupted when a detection occurs, and being continued in the next tree root. This locally reduces the hypothesis density as soon as an object is found. In order to avoid producing any systematic errors, all the child nodes are permutated randomly, so that their sequence is not correlated with their arrangement in the image. If, for example, the first child hypotheses are always located at the top on the left in the neighborhood area, then the detection has a tendency to be shifted in this direction.

Thus, starting from the single-stream hypothesis generated, a method is developed on the basis of this exemplary embodiment, by modeling a relaxed correspondence area and finally by various optimizations, requiring very little computation time despite the complex search area of the multistream data. In this case, the multigrid hypothesis tree makes a major contribution.

The use of the multigrid hypothesis tree is not only of major advantage for multisensor fusion purposes but is also particularly suitable for interaction with cascade classifiers in general and in this case leads to significantly better classification results.

1-18. (canceled)

19. A method for multisensor object detection/classification,
in which sensor information from at least two different sensor signal streams with different sensor signal characteristics is used for joint evaluation, in which the at least two sensor signal streams are directly combined or fused with one another for evaluation, in which, in this case, object-hypotheses are generated in each of the at least two sensor signal streams,
in which features for at least one classifier are generated on the basis of these object hypotheses,
and in which the object hypotheses are assessed and are associated with one or more classes by means of the at least one classifier, with at least two classes being defined and objects being associated with one of the two classes.

20. The method as claimed in claim 19, wherein the object hypotheses are unambiguously associated with one class.

21. The method as claimed in claim 19, wherein the object hypotheses are associated with a plurality of classes, with the respective association being allocated a probability.

22. The method as claimed in claim 19, wherein the object hypotheses are generated individually and independently of one another in each sensor signal stream in which case the object hypotheses of different sensor signal streams can then be associated with one another in an association step using association rules.

23. The method as claimed in claim 19, wherein object hypotheses are generated in one sensor signal stream and its (primary stream) and object hypotheses in the primary stream are projected into other sensor signal streams (secondary streams), with one object hypothesis in the primary stream producing one or more object hypotheses in the secondary stream.

24. The method as claimed in claim 23, wherein the projection of object hypotheses in the primary stream into a secondary stream is based on the sensor models used.

25. The method as claimed in claim 24, wherein, if the sensor models relate to image sensors, the projection of object hypotheses from the primary stream into a secondary stream is based on the positions of the image details within the primary stream or on the epipolar geometry.

26. The method as claimed in claim 19, wherein object hypotheses are described by one or more parameters which characterize object characteristics.

27. The method as claimed in claim 19, wherein object hypotheses are described by one or more search windows.

28. The method as claimed in claim 19, wherein object hypotheses are randomly scattered in a physical search area, or produced in a grid, or are produced by means of a physical model.

29. The method as claimed in claim 28, wherein the search area is adaptively restricted by one or more of the following presets:
beam angle
range zones
statistical characteristic variables which are obtained locally in an image, and
measurements from other sensors.

30. The method as claimed in claim 19, wherein the various sensor signal characteristics in the sensor signal streams are based on different positions and/or orientations and/or sensor variables of the sensors used.

31. The method as claimed in claim 30, wherein each object hypothesis is classified individually in its own right, in particular by means of weak learners and the results of the individual classifications are combined, with at least one classifier being provided, in particular at least one strong learner.

32. The method as claimed in claim 31, wherein features, in particular weak learners, of object hypotheses from different sensor signal streams are assessed jointly in the at least one classifier, in particular a strong learner, and are combined to form a classification result, in particular a strong learner.

33. The method as claimed in claim 19, wherein the grid in which the object hypotheses are produced is adaptively matched as a function of the classification result.

34. The method as claimed in claim 19, wherein the evaluation method by means of which the object hypotheses are assessed is automatically matched as a function of at least one previous assessment, in particular at least one classification result.

35. The method as claimed in claim 19, wherein at least two different sensor signal streams are used with a time offset,
or in that a single sensor signal stream is used together with at least one time-offset version thereof.

36. The method for multisensor object detection/classification as claimed in claim 19, in which the object hypotheses which are associated by means of the at least one classifier of one class for objects are used for tracking recognized objects.

37. The method for multisensor object detection/classification as claimed in claim 19, in which the object hypotheses which are associated by means of the at least one classifier with one class for objects are used for coverage of the surrounding area and/or for object tracking for a road vehicle.
